(19) United States
(12) Patent Application Publication
(10) Pub. No.: US 2023/0050952 A1
(43) Pub. Date: Feb. 16, 2023

(54) PERPETUAL CANDLE PRODUCT IMPLEMENTING A WICK AND OIL BURNING MECHANISM TO ALLOW FOR CONTINUED BURNING WITHOUT AFFECTING THE DESIGN FEATURE OF THE CANDLE PRODUCT

(71) Applicant: WE*HAVE*SOLUTIONS; LLC, Little Rock, AR (US)

(72) Inventor: Jerry Darsey, Little Rock, AR (US)

(21) Appl. No.: 17/400,692

(22) Filed: Aug. 12, 2021

(51) Int. Cl. F21L 19/00; F21V 35/00; C11C 5/00

(52) U.S. Cl. CPC F21L 19/00; F21V 35/00; C11C 5/008

(57) ABSTRACT

A “perpetual” candle product includes a container for storing an oil, a wick for drawing the oil from inside the container to an exposed end of the wick outside of the container, such that the tip of the exposed end of the wick can be ignited with a flame and the flame can continually burn so long as the oil in the container is replaced, and where a design feature is positioned outside the container and unlike a traditional candle the design feature does not burn or melt due to the flame on the wick, allowing the design feature (such as a wax rose, mimicking a real flower, or a wax cylinder, mimicking a traditional candle) to remain substantially intact despite prolonged and continuous burning of the candle product.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

Some statistics show that the global candle market was almost 3.5 billion US dollars 2018, with projections to reach over 6 billion US dollars by 2025. The massive size of the candle industry can be attributed to the use of candles as home décor and the fact that candles make great gifts for friends, family, and loved ones on birthdays or other holidays. Another item (or items) that are often used as beautiful home décor or as gifts to show love and affection are roses. Some sources report that over 250 million roses are produced every year for Valentine's Day alone. Roses are also popular to provide on Mother's Day, birthdays, employee appreciation days, and many other occasions. Given the nature of these candles and flowers as gifts on very special occasions, they've almost become symbols of the love shared between two people. In fact, the symbolism of the rose has been implemented in many romantic sayings: “Roses are red . . . violets are blue . . . ” and “Our love is as beautiful as this rose.”

Unfortunately, while the persons sharing these gifts with their loved ones would like to show the everlasting, perpetual nature of the love they share, both roses and candles have a limited shelf-life. Roses die. Candles melt. It's inherent in the nature of these products, and despite the unlimited feelings they've come to symbolize, these products themselves are limited. This is not only a blip in the symbolism these products are meant to embody, but the limited nature of these products (and candles in particular) leads to a lot of waste. One report, for example, found that despite all of the waste generated during the holiday season, candles are one of the worst offenders for Christmas-related landfill problems. When the candles are packaged in plastic or come with plastic holders (such as tea-light style candles), a candle product that burns and is used by consumers for 6-8 hours ends up sitting in a landfill for hundreds of years.

To reduce the waste created by limited-duration candle products and to provide a rose gift that can last as long as the love it is meant to symbolize, a candle product that can include a rose design that burns perpetually without losing the rose design is needed.

### BRIEF SUMMARY OF THE INVENTION

The present invention is generally directed to a candle product that implements a wick and oil burn mechanism that provides a perpetual candle product that incorporates a design feature that, unlike other candle products, does not burn as part of the burn mechanism of the candle product. Generally, the product of the present invention includes (a) a container with an internal compartment for storing the oil of the burn mechanism, (b) a wick that extends from the container's internal compartment to some distance outside of the container, the wick operable to draw the oil from the internal compartment to the point outside of the container in order to implement the burning of the burn mechanism, (c) a design feature positioned outside of the container, that, while appears to be part of the burning mechanism, is not actually part of the burning mechanism such that the design feature is not burned, melted, or otherwise reduced by use of the candle product.

In one embodiment, the design feature may be made of the same or similar wax material as traditional candles, but because the design feature is not part of the burning mechanism of the candle product, the design feature does not melt like traditional candle products, allowing the design feature to remain substantially complete so that the design feature lasts for a substantially endless period of time despite the use of the candle product. In one embodiment, the design feature appears in the shape of a rose or other flow. In one embodiment, the oil of the burn mechanism is a flammable oil product that is capable of being drawn by the wick from the internal compartment of the container to the end of the wick for burning. In one embodiment, the oil may be a fragrance oil that provides a desired fragrance when burned as part of the burn mechanism of the candle product. In one embodiment, the container substantially takes the form of a vase in order to provide a candle product that resembles a rose in a vase. In one embodiment, the container is surrounded by a cylindrical candle-shaped design feature, providing a candle product that resembles a traditional cylindrical candle. In one embodiment, the candle product includes a cylindrical candle-shaped design feature and a rose design feature. In one embodiment, the design features are made of wax or wax-look material to further mimic the look and feel of a traditional candle product.

These and other objects, features, and advantages of the present invention will become better understood from a consideration of the following detailed description of the preferred embodiments and appended claims in conjunction with the drawings as described following:

### BRIEF DESCRIPTION OF THE DRAWINGS

FIG. 1 illustrates one embodiment of the perpetual candle product of the present invention, having a rose-look design feature and a vase-shaped container.

FIG. 2 illustrates one embodiment of the perpetual candle product of the present invention, having a rose-look design feature and vase-shaped container, with the burning mechanism active to produce a flame.

FIG. 3 illustrates one embodiment of the perpetual candle product of the present invention, having a rose-look design feature and a cylindrical candle-shaped design feature enclosing the container.

FIG. 4 illustrates one embodiment of the perpetual candle product of the present invention, having a rose-look design feature and a cylindrical candle-shaped design feature enclosing the container, cutaway to show the internal aspects of the invention.

FIG. 5 illustrates one embodiment of the perpetual candle product of the present invention with a cylindrical candle-shaped design feature enclosing the container.

FIG. 6 illustrates one embodiment of the perpetual candle product of the present invention with a cylindrical candle-shaped design feature enclosing the container, cutaway to show the internal aspects of the invention.

FIG. 7 illustrates one embodiment of the perpetual candle product of the present invention with a vase-like container having a cork for substantially sealing the container and preventing oil spilling from the container.

FIG. 8 illustrates one embodiment of the perpetual candle product of the present invention with a cylindrical-shaped container having a cork for substantially sealing the container and preventing oil spilling from the container.

### DETAILED DESCRIPTION OF THE INVENTION

Generally speaking, the present invention is directed to a candle product that implements a wick and oil burn mechanism that provides a perpetual candle product that incorporates a design feature that, unlike other candle products, does not burn as part of the burn mechanism of the candle product. In the most basic of terms, the candle product of the present invention includes (a) a container 2 having an internal compartment 16 for holding oil 8 , (b) a wick 4 that extends from the internal compartment 16 of the container 2 to a point outside of the container 2 to facilitate the wicking of oil 8 from the container 2 to the exposed end 14 of the wick 4 outside of the container 2, allowing the tip of the exposed end 14 of the wick 4 to be lit with a flame 18, and (c) a design feature 10 positioned on or near the container 2, where the tip of the exposed end 14 of the wick 4 is a sufficient distance from the design feature 10 such that the design feature 10 does not burn or melt due to the flame 18 on the tip of the exposed end 14 of the wick 4. In one embodiment the candle product of the present invention also includes a tube 6 that is configured to surround at least a portion of the exposed end 14 of the wick 4, the tube 6 operable to provide an additional means for preventing the design feature 10 of the candle product from burning or melting due to the flame 18 on the tip of the exposed end 14 of the wick 4. Each of these elements is described more fully below.

While it may be seen from the embodiments described in detail below that a design feature 10 of the candle product appearing as a general rose configuration is contemplated, it should be noted that any number of configurations of design features 10 may be used. For example, while a rose shaped design feature 10 is shown and described, any number of different flower shaped design features 10 may be implemented within the scope of the present invention. Likewise, a design feature 10 not resembling a flower is also considered within the scope of the present invention, so a design feature 10 resembling some other object, shape, or configuration can be implemented. In this regard, one design feature 10, as shown and described more fully below, may be a design feature 10 that allows the candle product of the present invention to mimic a traditional candle. In that regard, the design feature 10 may simply be a cylindrical design feature 10 that has a solid surface 20 that surrounds the container 2, as described more fully below, allowing the design feature 10 to mimic the shape of a traditional candle. The primary feature of the design feature 10 is that the design feature 10 provides some ornamental design that, as described more fully below, does not burn or melt when the burn mechanism of the candle product is activated, and so long as that primary characteristic of the candle product of the present invention is achieved, the configuration or ornamental design of the design feature 10 may be modified as desired.

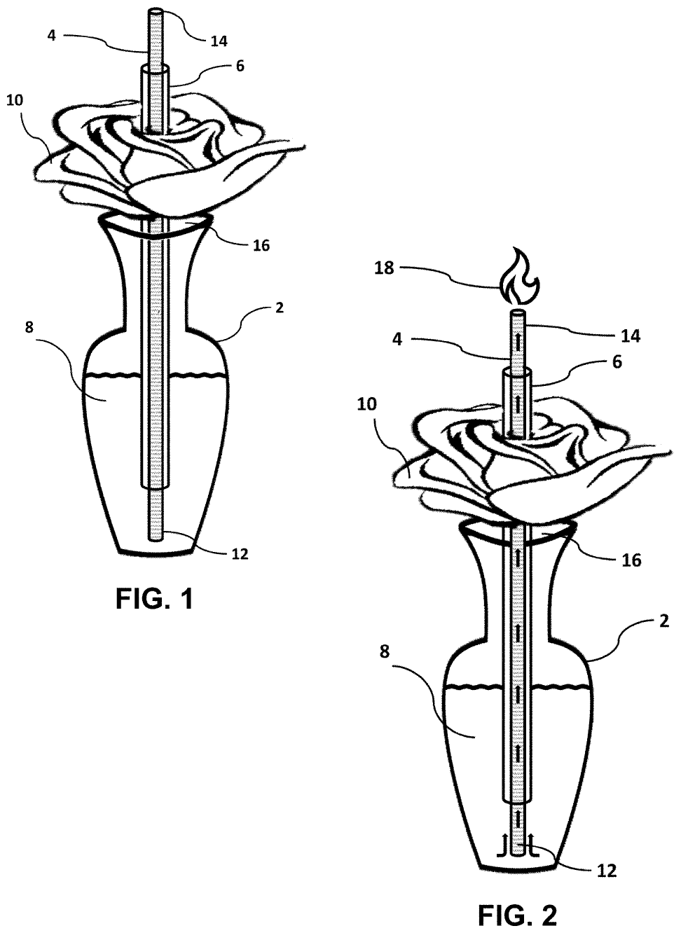

Turning to FIGS. 1-2, a first embodiment of a candle product according to the present invention may be described. As shown, the candle product includes a container 2 that hast he general appearance of a vase. The container 2 includes external surfaces that are joined together to create an internal compartment 16. The internal compartment 16 is configured to receive and store oil 8, which is utilized in the burn mechanism of the candle product of the present invention. The container 2 has an opening at one end that is operable to receive a wick 4, which is part of the burn mechanism of the candle product. The wick 4 is operable to extend into the internal compartment 16 of the container 2 so that a first end 12 of the wick 4 is submerged in the oil 8 that its stored inside the internal compartment 16 of the container 2 and such that a second end 14 of the wick 4 is exposed on the outside of the container 2, where this exposed end 14 of the wick 4 is intended to be lit with a flame 18 during activation of the burn mechanism of the candle product. In one embodiment, a tube 6 surrounds the wick 4, which not only provides an additional barrier between the wick 4 and the design feature 10, but also acts as a rigid pathway for the wick 4 to follow when inserting the wick 4 into the container 2. The tube 6 is preferably made of glass, which prevents the tube 6 from burning or melting when the burn mechanism is activated. In one embodiment, the design feature 10 is generally configured to mimic the ornamental design of a rose and the design feature 10 is configured to be positioned outside of the container 2 at some height along the tube 6, as to mimic a rose stem extending from a vase. The design feature 10 may be made of wax, which may be red wax to mimic the appearance of a rose. Oil 8 in the container 2 is drawn into the submerged end 12 of the wick 4, drawn through the wick 4 to the exposed end 14 of the wick 4, where the oil 8 is ignited to provide a flame 18. The exposed end 14 of the wick 4 extends a distance past the design feature 10 as to ensure that the design feature does not burn or melt from the flame 18 on the tip of the exposed end 14 of the wick 4. The tube 6 further aids in preventing burning or melting of the design feature 10, which in one embodiment, has a passageway through which the tube 6 and wick 4 extend.

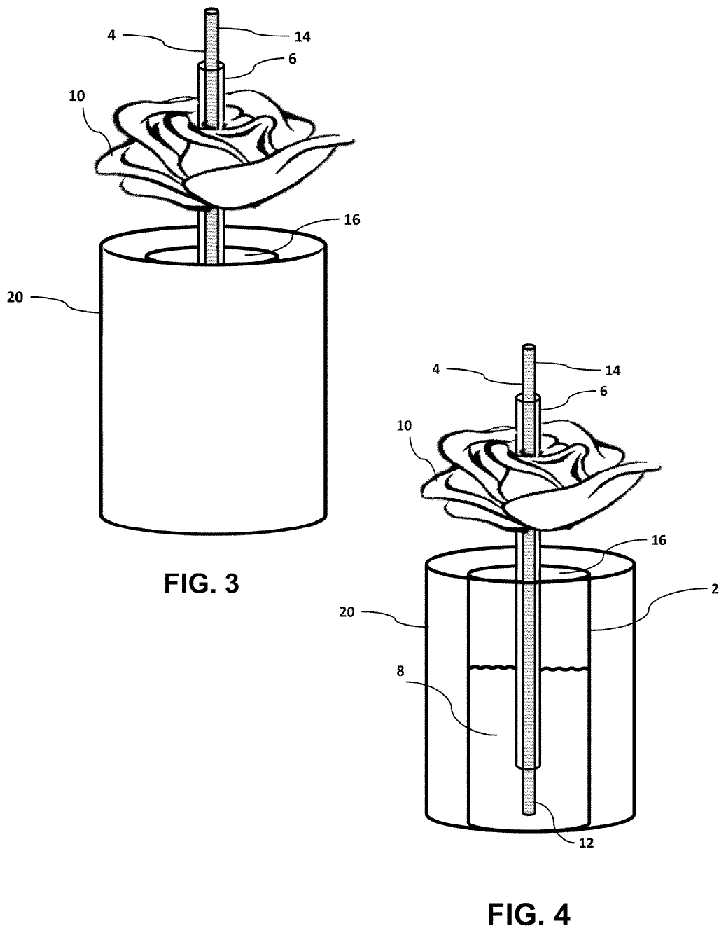

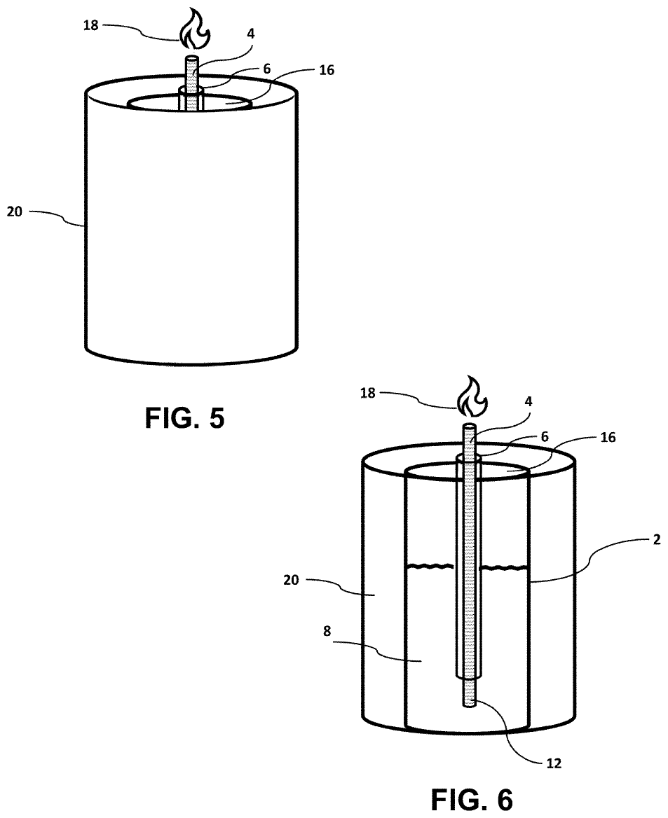

Turning to FIGS. 3-4, a second embodiment of a candle product according to the present invention may be described. The candle product includes a container 2 that is configured to be surrounded by a cylindrical design feature 20 having a solid surface that surrounds the container 2. This cylindrical design feature 20 may be made of wax, which allows the candle product to mimic the cylindrical design of a traditional candle. Unlike a traditional candle, however, a container 2 is positioned inside the cylindrical design feature 20, where the container 2 has an internal compartment 16 for receiving and storing oil 8. The container 2 has an opening at one end that is operable to receive a wick 4, which is part of the burn mechanism of the candle product. The wick 4 is operable to extend into the internal compartment 16 of the container 2 so that a first end 12 of the wick 4 is submerged in the oil 8 that its stored inside the internal compartment 16 of the container 2 and such that a second end 14 of the wick 4 is exposed on the outside of the container 2, where this exposed end 14 of the wick 4 is intended to be lit with a flame 18 during activation of the burn mechanism of the candle product. As noted previously, a tube 6 may also be utilized. In one embodiment, an additional design feature 10 may be implemented to provide both the traditional look of a candle via the cylindrical design feature 20 and the traditional look of a rose or flower via the additional design feature 10. However, it is also contemplated that only the cylindrical design feature 20 may be implemented, as shown, for example, in FIGS. 5-6. In any event, the wick 4 extends from the container 2 so that that exposed end 14 of the wick extends sufficiently from the cylindrical design feature 20 as to prevent the cylindrical design feature 20 from burning or melting when the exposed end 14 of the wick is ignited.

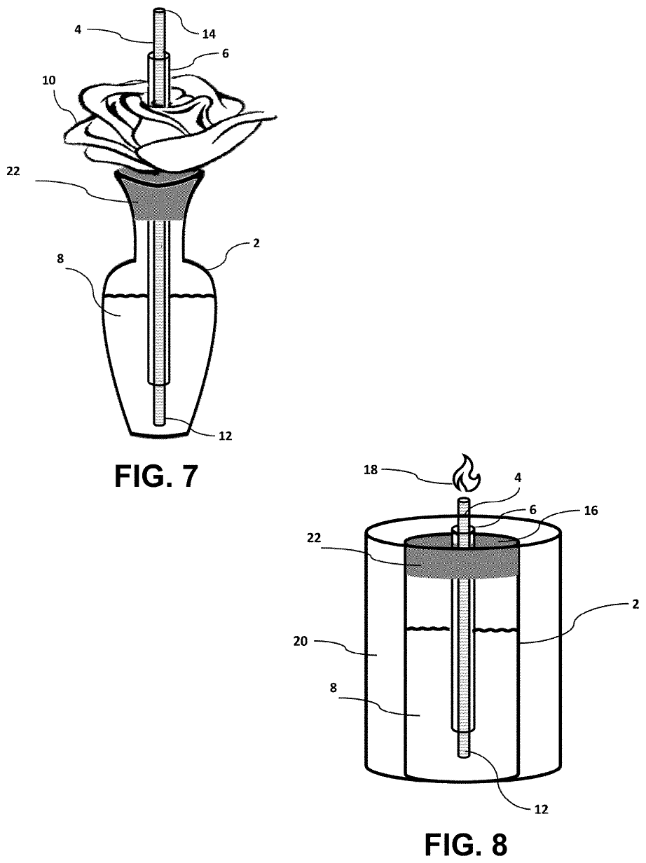

In various embodiments, as shown for example in FIGS. 7-8, a cork 22 may be placed at the opening of the internal compartment 16 of the container 2 as to prevent accidental spillage of the oil 8 inside the container 2. The cork 22 would include a aperture along a central axis to provide a space for the wick 4 and tube 6 to extend through the cork 22, allowing the submerged end 12 of the wick 4 to be inserted into the oil 8 in the container 2. The cork 22 can be sized to fit the opening in the container 2, allowing the cork 22 to be utilized in any configuration, such as when the cork is sized to fit the opening in a container with a vase-like shape (FIG. 7, for example) or the cork 22 is sized to allow the cork 22 to fit the opening in a container 2 with a generally cylindrical shape (FIG. 8, for example). The cork 22 may be operable to be inserted and removed from the opening in the container 2, so as to allow the oil 8 to be refilled as needed. It may be seen that because the oil 8 can be refilled into the container 2, the candle product of the present invention can be burned perpetually so long as the oil 8 is refilled, and that even with prolonged, continuous, and essentially perpetual burning of the candle product, the design feature 10, 20 positioned outside the container will be substantially unaffected by the burning of the candle product. Thus, even with a wax design product 10, 20, such as a wax rose design product 10, or the wax cylinder design feature 20 mimicking a traditional candle, the design feature 10 will be substantially unaffected (i.e. no melting), a complete departure from existing candle products in which the wax features melt, losing their shape, function, and design.

The container 2 of the present invention can be made of any durable product suitable for receiving and storing the oil 8. In the preferred embodiment, the container 2 is made of glass. The wick 4 of the present invention can be made of any material suitable for drawing oil 8 from the container 2 and through the wick 4 for ignition. In the preferred embodiment, the wick is made of braided cotton. The oil 8 can be made of any hydrocarbon oil or fuel that is suitable for wicking through the wick 4 and ignition at the flame. In the preferred embodiment, the oil 8 is lamp oil. In one or more embodiments, the oil 8 may include a fragrance as to provide fragrance when the oil 8 is ignited by the flame 18. A design feature 10, 20 of the present invention can be made of any material suitable to provide ornamental design. In the preferred embodiment, the design feature 10, 20 is made of wax, which may be colored wax. The tube 6 of the present invention can be made of any material durable enough to provide a barrier between the wick 4 and design feature 10, 20. In the preferred embodiment, the tube 6 is made of glass. In one embodiment, the tube 6 extends past the height of the design feature 10 at least one-quarter (¼) inch, as to more efficiently act as a barrier between the design feature 10 and wick 4 and to prevent the wick 4 from burning down to the design feature 10. The tip of the exposed end 14 of the wick 4 preferably extends past the height of the tube 6 another one-quarter (¼) inch. In one embodiment, the submerged end 12 of the wick 4 may include a long length of extra wick so that as the exposed end 14 of the wick 4 burns from the flame 18, the user can pull the wick 4 at its exposed end 14 to have sufficient wick at the exposed end 14 to extend from the tube 6, while still providing sufficient wick 4 at the submerged end 12 to draw the oil 8.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a Markush group or other grouping is used herein, all individual members of the group and all combinations and subcombinations possible of the group are intended to be individually included. All references cited herein are hereby incorporated by reference to the extent that there is no inconsistency with the disclosure of this specification. When a range is stated herein, the range is intended to include all sub-ranges within the range, as well as all individual points within the range. When “about,” “approximately,” or like terms are used herein, they are intended to include amounts, measurements, or the like that do not depart significantly from the expressly stated amount, measurement, or the like, such that the stated purpose of the apparatus or process is not lost.

The present invention has been described with reference to certain preferred and alternative embodiments that are intended to be exemplary only and not limiting to the full scope of the present invention, as set forth in the appended claims.

1. A candle product useful for providing an ornamental design unaffected by burning the candle product, the candle product comprising:
a. a container having an internal compartment configured to receive an oil;
b. a wick having a first end and a second end, wherein the first end of the wick is configured to be inserted into the internal compartment and to be submerged in the oil, thereby providing a submerged end of the wick, and further wherein the second end of the wick is configured to remain outside of the container, thereby providing an exposed end of the wick;
c. a design feature positioned outside of the container, the design feature comprising an ornamental design;
wherein the wick is operable to draw the oil from the submerged end of the wick to the exposed end of the wick, wherein at least a portion of the exposed end is configured to be ignited with a flame, and wherein the design feature remains substantially unaffected by the flame.

2. The candle product of claim 1, wherein the design feature comprises a wax rose.

3. The candle product of claim 1, wherein the design feature comprises a wax cylinder substantially surrounding the container to mimic a traditional candle product.

4. The candle product of claim 1, wherein the wick extends through the design feature, wherein the exposed end of the wick is positioned outside the design feature.

5. The candle product of claim 4, further comprising a tube having an internal passageway operable to receive the wick, wherein the tube extends through the design feature, thereby acting as a passageway through the design feature through which the wick is extended.

6. The candle product of claim 1, wherein the oil comprises lamp oil.

7. The candle product of claim 1, wherein the oil comprises a fragrance.

8. The candle product of claim 1, further comprising a cork configure to seal the container.

9. The candle product of claim 8, wherein the cork comprises a passageway configured to receive the wick such that the first end of the wick extends through the cork into the container.
